(19) United States
(12) Patent Application Publication
(10) Pub. No.: US 2025/0014851 A1
(43) Pub. Date: Jan. 9, 2025

(54) SWITCHING DEVICE WITH A STOPPER AND METHOD FOR OPERATING A SWITCHING DEVICE

(71) Applicant: Eaton Intelligent Power Limited, Dublin, 4 (IE)

(72) Inventors: Volker LANG, Bonn, NRW (DE); Lutz FRIEDRICHSEN, Langerwehe, NRW (DE); Christoph BAUSCH, Bonn, NRW (DE)

(21) Appl. No.: 18/710,705

(22) PCT Filed: Nov. 30, 2022
(86) PCT No.: PCT/EP2022/025544

§ 371 Date: May 16, 2024

(30) Foreign Application Priority Data
Dec. 6, 2021 (EP) 2117585.6

(51) Int. Cl. H01H 50/54

(52) U.S. Cl. CPC H01H 50/541

(57) ABSTRACT

Some embodiments relate to a switching device comprises a first and a second fixed contact, a contact bridge, a first and a second movable contact arranged at the contact bridge, a contact spring, a contact bridge carrier, a housing and at least one stopper. The contact bridge carrier is movable and is coupled to the contact bridge via the contact spring. The at least one stopper is connected to the housing, and is configured to limit a movement of the contact bridge in case of a short circuit. The switching device also comprises a magnetic drive assembly with an electric coil, a magnetic core and an armature, wherein the armature is movable and is connected to the contact bridge carrier.

### CROSS-REFERENCE TO RELATED APPLICATIONS

This application is a national phase filing under 35 C.F.R. § 371 of and claims priority to PCT Patent Application No. PCT/EP2022/025544, filed on Nov. 30, 2022, which claims the priority benefit under 35 U.S.C. § 119 of Great Britain Patent Application No. 2117585.6, filed on Dec. 6, 2021, the contents of which are hereby incorporated in their entireties by reference.

### BACKGROUND

The present disclosure is related to a switching device with a stopper and a method for operating a switching device.

The switching device is realized as electromechanical switching device, e.g. for conducting and switching bidirectional DC currents, especially for a high-power battery network in the field of electro-mobility. The switching device is also configured for safe disconnecting in case of a short circuit.

Within short-circuit switching of a protective switching device, strong dynamic forces react on the contact system due to the high currents. The resulting strong opening impulse can lead to rebound and re-contacting of the contact system. Reclosing of the contacts can result in different issues: Due to the reclosing the device does not achieve galvanic isolation. Reclosing of the contacts can lead to recurring bouncing, since the short-circuit current can flow again when the contacts are closed; this may lead to repeating the initial issue. Due to the reclosing the extinguishing time and the stress in the switching device increases.

### SUMMARY

Document WO 2020/035489 A1 describes a switching device for carrying and disconnecting bidirectional DC currents.

It is an object to provide a switching device and a method for operating a switching device that reduces the probability for an unintentional re-contacting of the switching contacts.

These objects are achieved by the subject-matter of the independent claims. Further developments and embodiments are described in the dependent claims.

There is provided a switching device, comprising a first and a second fixed contact, a contact bridge, a first and a second movable contact arranged at the contact bridge, a contact spring, a contact bridge carrier, a magnetic drive assembly with an electric coil, a magnetic core and an armature, a housing and at least one stopper. The contact bridge carrier is movable and is coupled to the contact bridge via the contact spring. The armature is movable and is connected to the contact bridge carrier. The at least one stopper is connected to the housing and is configured to limit a movement of the contact bridge in case of a short circuit.

Advantageously, the at least one stopper obtains the function of a brake or limiter of the movement of the contact bridge in case of a short circuit. By reducing the kinetic energy of the contact bridge during forced contact bridge opening induced by high energy short circuit arcs, the probability of re-connecting is reduced.

In an embodiment, the switching device is configured such that a short circuit current flowing in case of a short circuit through the first fixed contact, the first movable contact, the contact bridge, the second movable contact and the second fixed contact and a movement of the contact bridge carrier causes a movement of the contact bridge from an on-position of the contact bridge in a switched-on state of the switching device to the at least one stopper.

In an embodiment of the switching device, a maximum clearing distance is a maximum distance of a movement of the contact bridge from an on-position of the contact bridge in a switched-on state of the switching device to the at least one stopper in case of a short circuit.

If the maximum clearing distance is too small, the risk of arc sticking increases. If the maximum clearing distance is too large, the risk of re-contacting increases.

In an embodiment of the switching device, the at least one stopper and a part of the housing that is connected to the at least one stopper are made of the same material. For example, the at least one stopper is out of a polymer. For example, the at least one stopper and the part of the housing that is connected to the at least one stopper are fabricated by injection molding.

In an embodiment of the switching device, the at least one stopper is out of a first material and the part of the housing that is connected to the at least one stopper is out of a second material. The at least one stopper is attached to the housing.

In an embodiment of the switching device, the contact bridge carrier and the contact bridge are configured such that a relative movement of the contact bridge in relation to the contact bridge carrier from an on-position of the contact bridge in a switched-on state of the switching device is limited to an end stop distance in case of a short circuit. If the end stop distance is too small, an arc sticking or a double connection may occur.

In an embodiment of the switching device, the relative movement of the contact bridge in relation to the contact bridge carrier from an on-position of the contact bridge in a switched-on state of the switching device is limited by at least one bumper connected to the contact bridge carrier and/or a block length of the contact spring. A block length is the length of the contact spring with coils directly adjacent to each other. In other words, the contact spring can only be compressed up to the block length.

In an embodiment of the switching device, the end stop distance depends on the maximum clearing distance.

In an embodiment of the switching device, the end stop distance has a value F according to the equation:

$$Fmin = 4.8 mm + \frac{E - 6.3 mm}{2} \leq F \leq 5.6 mm + \frac{E - 6.3 mm}{2} = Fmax$$

wherein Fmin and Fmax are a minimum and a maximum value of the end stop distance and E is a value of the maximum clearing distance.

In an example, the maximum clearing distance is in a range between 6.3 mm and 8.6 mm. Thus, the end stop distance is in a range between 4.8 mm and 6.8 mm.

In an embodiment of the switching device, a clearing distance is the distance of a movement of the contact bridge from an on-position of the contact bridge in a switched-on state of the switching device to an off-position of the contact bridge in a switched-off state of the switching device in the absence of a short circuit. If the clearing distance is too small, there is a risk of arc sticking and re-contacting.

In an embodiment of the switching device, the maximum clearing distance is larger than the clearing distance.

In an embodiment, the maximum clearing distance depends on the clearing distance.

In an embodiment of the switching device, the maximum clearing distance has a value E according to the equation:

$$B + 1.2 mm \leq E \leq B + 2. mm ,$$

wherein B is a value of the clearing distance.

In an example, the clearing distance is in a range between 5.1 mm and 6.6 mm.

In an embodiment of the switching device, the contact bridge carrier comprises a limiter. The limiter is configured to limit a movement of the contact bridge inside the contact bridge carrier towards the first and the second fixed contact.

In an embodiment of the switching device, the switching device includes a return spring. One side of the return spring is in contact with the housing. The other side of the return spring is coupled to the contact bridge carrier. The switching device includes e.g. a part or parts which connect the other side of the spring to the contact bridge carrier. The part or the parts provide a force from the return spring on the contact bridge carrier. The return spring is configured to provide a force to the contact bridge carrier in a direction away from the first and the second fixed contact.

In an embodiment, the switching device comprises a magnetic drive assembly with an electric coil, a magnetic core and an armature. The armature is movable. The armature is connected or directly attached to the contact bridge carrier.

In an embodiment, the switching device is configured that the movement of the contact bridge relative to the contact bridge carrier in case of a short circuit starts before the armature starts to move.

In an embodiment of the switching device, the housing is configured to limit a movement of the armature. The contact bridge provides a force via the contact spring and the contact bridge carrier to the armature. In case of a short circuit, a current sensor of the switching device detects that a load current is above a predetermined limit and indicates a short circuit. A load current being above the predetermined limit can be named short-circuit current or overload current. The current sensor triggers that the electric coil is quickly de-energized resulting in movement of the armature. The movement of the armature and the force described above are in the same direction. The movement of the armature is limited by the housing. A kinetic energy of the armature is reduced by the hit of the armature on the housing.

In an embodiment of the switching device, the contact bridge is configured to perform a linear movement
in case of a short circuit,
at a transition from a switched-off state to a switched-on state of the switching device, and
at a transition from the switched-on state to the switched-off state of the switching device.

In an embodiment, the switching device comprises a first terminal contact at which the first fixed contact is attached and a second terminal contact at which the second fixed contact is attached. The first and the second terminal contact are both bended in a U-form or U-shape.

There is provided a method for operating a switching device. The switching device comprises a first and a second fixed contact, a contact bridge, a first and a second movable contact arranged at the contact bridge, a contact spring, a contact bridge carrier which is movable and is coupled to the contact bridge via the contact spring, a housing, at least one stopper connected to the housing and a magnetic drive assembly with an electric coil, a magnetic core and an armature, wherein the armature is movable and is connected to the contact bridge carrier. The method comprises: Limiting a movement of the contact bridge by the at least one stopper in case of a short circuit.

Advantageously, the switching device realizes a mechanical system to minimize contact rebound in a short circuit switching device. The DC switching device obtains an improved short circuit switching behavior due to the at least one mechanical stopper.

The method for operating a switching device may be implemented e.g. by the switching device according to one of the embodiments defined above. Thus, features disclosed with respect to the method can be used with respect to the switching device and vice versa.

In an example, the switching device is implemented as DC switching device with improved short-circuit switching behavior resulting from mechanical end stops. The mechanical system minimizes contact rebound in short-circuit switching devices, uses mechanical end stops at a predefined distance to decrease energy and thus prevents the contact system from re-contacting. To minimize rebound, kinetic energy in the contact system is reduced. A solution to minimize this energy is e.g. to optimize at least one of the following parameters: Distance before reaching an end stop, clearing distance, maximum clearing distance, overtravel and travel of the magnetic actuator. An ideal coordination of these values may result in a fast and homogeneous arc run and in no re-contacting in the event of high short-circuit currents.

In an example, the DC switching device is realized for switching load and overload currents, in particular short-circuit currents. The switching device prevents a re-contacting of the switching device which may occur due to the high dynamics after a short-circuit disconnection.

In an example, the construction of the switching device is similar to that of a conventional contactor. The switching device includes an electromagnetic drive and a contact/quench system. Unlike the contactor, the contact/quenching system, in combination with a special tripping mechanism, can also handle very high short-circuit currents.

In an example, the contact apparatus is rigidly coupled to the armature of the electromagnetic drive. Due to the resulting arc after the electrodynamic lift-off in the short-circuit case and the resulting pressure build-up within the switching chamber, the armature movement in the “off” direction is significantly faster than when a load current is switched off. The greater acceleration of the armature can cause the armature with the rigidly coupled contact apparatus to bounce back toward “on” so strongly after reaching the end position that the fixed and movable contacts re-contact. This would cause a short-circuit current to flow again.

In an example, re-contacting/re-bouncing can be prevented by a coordination of e.g. at least one of the idle stroke of the contact system, the maximum clearing distance in the case of an overload and the maximum free travel of the movable contact piece.

In the event of a short circuit, the movable contact piece can in principle be opened by two mechanisms: The first is electrodynamic lift-off due to the high Holm's force, which in the case of short-circuit currents exceeds the contact pressure force caused by the compressed contact pressure spring. In the case of the switching device, the Holm's force acts directly on the contact. The current direction within the contact results in an antiparallel current direction which then results in the lift-off force (microscopic). The contacts open even though the electromagnetic actuator is still closed. The limit can be set by a stop in the contact bridge carrier or by the block length of the contact spring. The maximum contact opening distance, caused by an electrodynamic lift-off, is referred to in the following as the end stop distance or maximum free travel of the movable contact bridge.

The second is the opening movement initiated by the armature and the rigidly connected contact apparatus. After the overload current is detected, a rapid de-energization of the electric coil of the electromagnetic actuator occurs. As a result, the armature with the rigidly connected contact apparatus is moved by the contact springs and impression springs towards the off-position, causing the contacts to open at the start of the idle stroke.

In the normal load case, contact opening occurs only via the de-energization of the drive electric coil. In the case of overload, a combination of the two mechanisms occurs, whereby, due to the low inertial mass, the electrodynamic lift-off occurs more quickly in terms of time. Both mechanisms are independent of each other. Thus, the theoretically achievable contact opening distance would be the sum of maximum free flight and the empty stroke. A large contact opening distance is helpful for the arc to leave the contacts quickly, but the probability of re-contact increases due to the highly preloaded contact spring. Therefore, it is advantageous to limit the maximum clearing distance to a reasonable value so that the arc run is not inhibited, but the contact spring is already relaxed again. In this case, the movable contact bridge reaches the stop before the armature has reached its end stop. This task is solved constructively by a stopper in the switching chamber for the movable contact bridge.

In an example, the parameters end stop distance (also named maximum free travel), clearing distance (also named idle stroke or free stroke) and maximum clearing distance can be selected in such a way that the following functions are ideally solved: Fast, homogeneous arc travel; no re-contacting at high short-circuit currents; and minimum pull-in power of the electromagnetic drive. In this example, outside these ranges, either arc travel may be inhibited or mechanical re-contacting may occur, when very large short circuit currents are cut off.

In an example, the switching device is implemented as an electromechanical switching device for conducting and switching bidirectional DC currents, especially for high-power battery networks in the field of electro-mobility.

The switching device is e.g. a part of an electric vehicle and/or hybrid vehicle. The switching device is e.g. realized as a contactor and/or circuit breaker. The switching device is e.g. implemented as switching in air or as a gas-tight sealed switching device.

The following description of figures of embodiments may further illustrate and explain aspects of the switching device. Parts and devices with the same structure and the same effect, respectively, appear with equivalent reference symbols. In so far as parts or devices correspond to one another in terms of their function in different figures, the description thereof is not repeated for each of the following figures.

### DESCRIPTION OF DRAWINGS

FIGS. 1 to 4 show an example of a switching device in different states or phases;

FIG. 5A shows a detail of an example of a contact area of a switching device and FIGS. 5B and 5C show further details of an example of a switching device;

FIGS. 6A to 6C show characteristics of different examples of a switching device; and

FIG. 7 shows examples of values of parameters of a switching device.

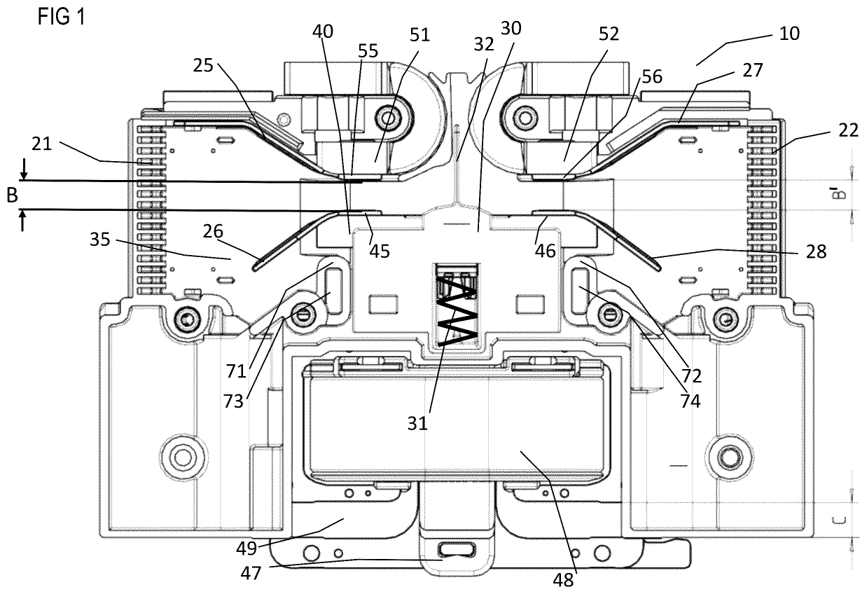

FIG. 1 shows an example of a switching device 10. The switching device 10 comprises a first movable contact 45, a second movable contact 46, a first fixed contact 55, a second fixed contact 56 and a contact bridge 40. The contact bridge 40 is realized as a cuboid. The contact bridge 40 is e.g. made of copper. The contact bridge 40 may be called switching bridge or switching contact bridge. The first and the second movable contact 45, 46 are fixed on the contact bridge 40. The first and the second movable contact 45, 46 are made of metal, e.g. of silver oxide material. A thickness of the first and the second movable contact 45, 46 is e.g. in a range between 0.5 mm to 1.5 mm (0.5 mm is equal to 500 μm; 1.5 mm is equal to 1500 μm).

### DETAILED DESCRIPTION

The switching device 10 includes a first terminal contact 51 and a second terminal contact 52. The first fixed contact 55 is fixed on the first terminal contact 51. The second fixed contact 56 is fixed on the second terminal contact 52. The first and the second fixed contact 55, 56 are made of metal, e.g. of silver oxide material. A thickness of the first and the second fixed contact 55, 56 is e.g. in a range between 0.5 mm to 1.5 mm. The first and the second terminal contact 51, 52 have a bended form. The first and the second terminal contact 51, 52 have a U-form. The first and the second terminal contact 51, 52 are e.g. out of copper.

The switching device 10 comprises a contact bridge carrier 30. The contact bridge carrier 30 is e.g. of plastics. The contact bridge carrier 30 is e.g. of a polymer, such as a thermoplastic or thermoset material. The material of the contact bridge carrier 30 has e.g. high dimensional and temperature stability as well as electrical resistance against currents at its surface. The contact bridge 40 is inserted into the contact bridge carrier 30. In FIG. 1, the contact bridge 40 is partly “behind” the contact bridge carrier 30. The switching device 10 comprises a contact spring 31 that can be named contact pressure spring. The contact spring 31 couples the contact bridge 40 to the contact bridge carrier 30. The contact spring 31 is realized e.g. as a compression spring or a tension/compression spring.

Moreover, the contact bridge carrier 30 comprises a barrier 32 that is arranged in the space between the first and the second terminal contact 51, 52. The barrier 32 is located in an isolating manner between the first and the second terminal contact 51, 52. The barrier 32 is free of contact to the first and to the second terminal contact 51, 52. The barrier 32 has the form of a plate. The barrier 32 and the contact bridge carrier 30 are fabricated e.g. out of the same material. The contact bridge carrier 30 and the barrier 32 are advantageously fabricated as one part.

Moreover, the switching device 10 comprises a magnetic drive assembly. The magnetic drive assembly may be also named electromechanical switching drive or magnetic actuator. The magnetic drive assembly comprises an electric coil 48, a magnetic core 50 and an armature 47. The electric coil 48 is fixed in the magnetic core 50. The housing 35 is e.g. made of a thermoplastic or thermoset material. The armature 47 is fastened to the contact bridge carrier 30. The armature 47 is coupled via the contact bridge carrier 30 and the contact spring 31 to the contact bridge 40. The contact spring 31 is e.g. made of steel such as inox steel. The contact spring 31 presses the contact bridge 40 in the direction of the first and second terminal contact 51, 52. The contact spring 31 fixes the contact bridge 40 in its target position. The contact spring 31 preloads the contact bridge with a defined force. The contact spring 31 ensures an appropriate contact force when the switching device 10 is in the switched-on state. The contact spring 31 provides a force to the contact bridge 40 in a direction towards the first and the second fixed contact 55, 56.

The switching device 10 comprises at least a stopper, e.g. a first and a second stopper 71, 72. The first and the second stopper 71, 72 projects out of the housing 35. The first and the second stopper 71, 72 is e.g. integrally connected to the housing 35. In this case, the stopper 71, 72 are made e.g. of the same material as the housing 35. The first stopper 71 includes an opening 73 and the second stopper 72 includes an opening 74. The first and the second stopper 71, 72 may have the form of hollow cylinders (also named cylindrical shell) or elongated hollow cylinders.

Furthermore, the switching device 10 comprises a first arc runner 25 connected to the first terminal contact 51. Moreover, the switching device 10 comprises a second arc runner 26 connected to the contact bridge 40 in vicinity of the first movable contact 45. Additionally, the switching device 10 comprises a third arc runner 27 connected to the second terminal contact 52. Moreover, the switching device 10 comprises a fourth arc runner 28 connected to the contact bridge 40 in vicinity of the second movable contact 46.

A first arcing chamber 21 of the switching device 10 is connected to the first arc runner 25. A second arcing chamber 22 of the switching device 10 is connected to the third arc runner 27. The first and the second arcing chamber 21, 22 comprise a number of splitter plates (not shown). Moreover, the switching device 10 is surrounded by a permanent magnet system (not shown) having a permanent magnet and a first and a second pole plate. The contact bridge 40, the first and the second terminal contact 51, 52 and the first and the second arcing chamber 21, 22 are arranged between the first and the second pole plate.

In FIGS. 1 to 4, the operation of an example of the switching device 10 is shown. The switching device 10 is configured as a bidirectional DC switching device. The switching device 10 is configured to be set in a switched-on state or a switched-off state.

In FIG. 1, the example of the switching device 10 is shown in the switched-off state. In other words, the switching device 10 is in an operationally switched-off state (normal switch-off, no fault case). In the switched-off state of the switching device 10, the contact bridge 40 is in an off-position. In the switched-on state of the switching device 10, the contact bridge 40 is in an on-position.

In the switched-off state, the first and the second fixed contact 55, 56 are not in contact with the first and the second movable contact 45, 46. Thus, a flow of a load current from the first terminal contact 51 to the second terminal contact 52 via the contact bridge 40 is inhibited. The switching device 10 is set from the switched-on state into the switched-off state by a movement of the contact bridge 40 that separates the contact bridge 40 from the first and the second terminal contact 51, 52. The movement is effected by movement of the armature 47 of the magnetic drive assembly, to which the contact bridge 40 is coupled. In case of a load current flowing before switching, a first arc may be generated between the first fixed contact 55 and the first movable contact 45 and a second arc may be generated between the second movable contact 46 and the second fixed contact 56.

A clearing distance B is a distance of a movement of the contact bridge 40 from an on-position of the contact bridge 40 to an off-position of the contact bridge 40. In other words, the clearing distance B is a distance between a surface of the first fixed contact 55 and a surface of the first movable contact 45. The switching device 10 is e.g. symmetrical to a middle axis. Thus, the clearing distance B is equal or approximately equal to a further clearing distance B′ between a surface of the second fixed contact 56 and a surface of the second movable contact 46. Due to fabrication tolerances and the effects of previous arcs, the clearing distance B and the further clearing distance B′ may not be identical. In the switched-off state of the switching device 10, there is an airgap 49 between the armature 48 and the magnetic core 50.

At the transition between the switched-on state to the switched-off state, the armature 47 pulls the contact bridge carrier 30 and the contact bridge 40 away from the first and the second terminal contact 51, 52. A travel distance C of the armature 47 can also be called travel distance of the magnetic drive assembly and is shown in FIG. 1. The travel distance C is the distance which the armature 47 is moved from a switched-on state to a switched-off state of the switching device 10. The clearing distance B and the travel distance C can be measured e.g. by a device for length or distance measurement in case the switching device 10 is not operated and is opened. Typically, the switching device 10 is a normally off device. The device for length or distance measurement is e.g. a laser distance measurement device or a laser triangulation device or a caliper. In general a stroke or a movement of the armature 47 is easily measured by such a device for length or distance measurement. Parameters which cannot be measured directly can be calculated.

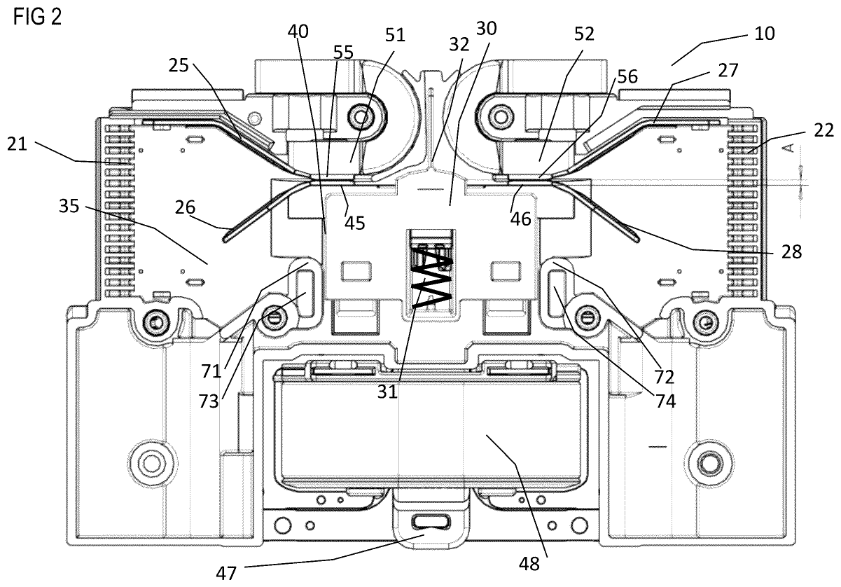

FIG. 2 shows the example of the switching device 10 shown in FIG. 1 in the switched-on state. Here, the contacting of the pole faces of the armature 47 and magnetic core of the magnetic drive assembly together with the contact spring 31 causes the closing of the contact bridge 40 and the contacting of the two movable contacts 45, 46 with the two fixed contacts 55, 56 with a contact force configured for the permanent conduction of the rated current. Thus, a load current can flow from the first terminal contact 51 via the first fixed contact 55, the first movable contact 45, the contact bridge 40, the second movable contact 46 and the second fixed contact 56 to the second terminal contact 52.

An overtravel distance A is shown in FIG. 2. The overtravel distance A is the distance the armature 47 is moved beyond the point in which both of the movable contacts 45, 46 touch both of the fixed contacts. Thus, the contact spring 31 is compressed by the contact bridge carrier 30. The contact spring 31 becomes shorter by the overtravel distance A in comparison to a released contact spring 31. The overtravel distance A can be measures or calculated. The contact spring 31 is slightly compressed compared to the switched-off state to apply the contact force appropriate for a permanent current flow. Advantageously, the overtravel distance A assures that the switching device 10 is in the switched-on state even in case of a vibration applied to the switching device 10 or a reduction of the thickness of the movable contacts 45, 46 or the fixed contacts 55, 56 as an effect of previous arcs.

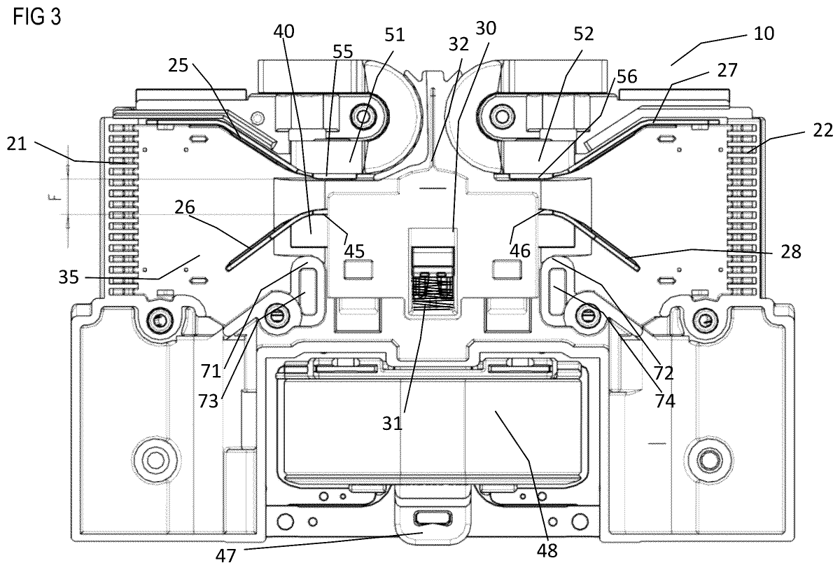

FIG. 3 shows the example of the switching device 10 shown in FIGS. 1 and 2 in case of a short circuit. The words “in case of a short circuit” could be replaced e.g. by the words “in the event of a short circuit”. In FIG. 3, a first phase of a short circuit is illustrated. In the first phase of the short circuit (e.g. with a high short circuit current), a dynamic tearing open of the movable contacts 45, 46 occurs. In this case shown in FIG. 3, the contact bridge 40 moves downwards, while the armature 47 is still in the position for a switched-on state of the switching device 10. The contact spring 31 is highly compressed. The compression of the contact spring 31 in the first phase is higher than the compression of the contact spring 31 in the switched-on state of the switching device 10.

In the first phase of the short circuit, the contact bridge 40 moves with respect to the housing 35 or the two fixed contacts 55, 56 and the contact bridge carrier 30 is free of a movement. Thus, the contact bridge 40 performs a relative movement in relation to the contact bridge carrier 30. The movement from an on-position of the contact bridge 40 is limited to an end stop distance F in case of a short circuit. The relative movement of the contact bridge 40 with respect to the contact bridge carrier 30 can obtain the end stop distance F at most.

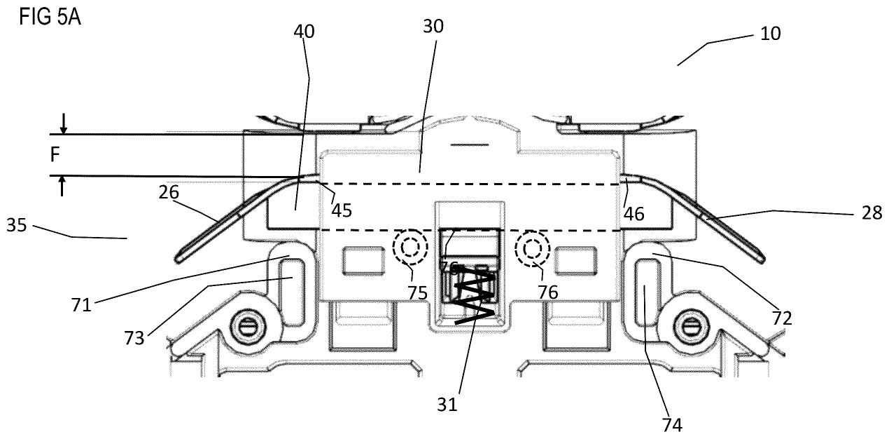

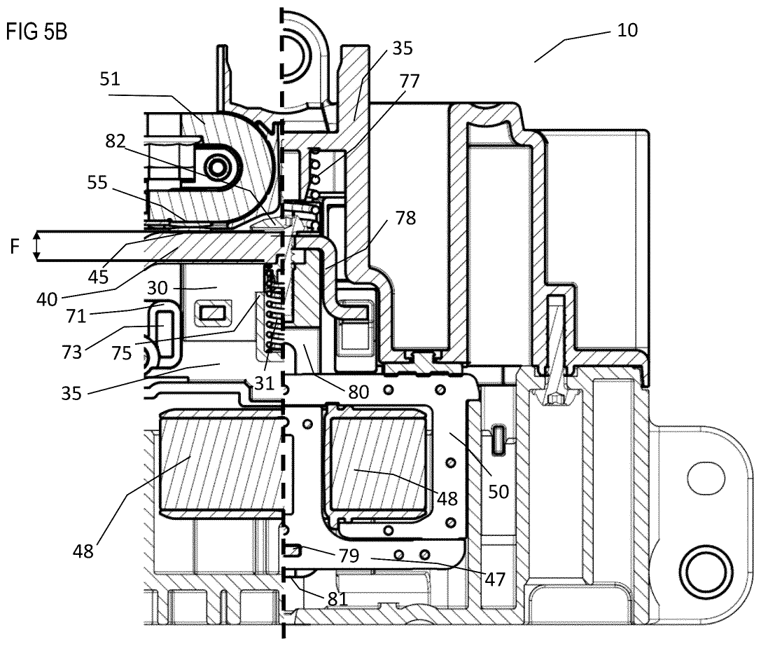

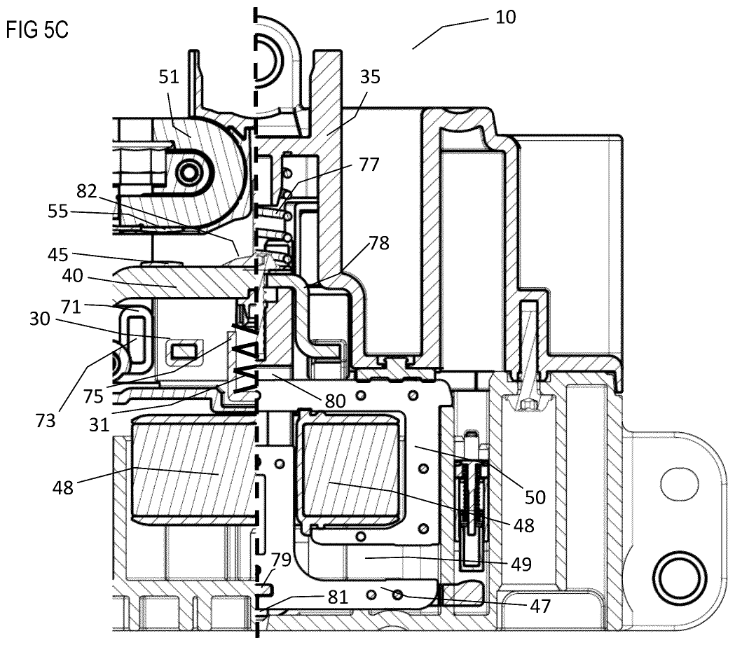

In an example, the movement is stopped by the contact spring 31. The contact spring 31 has a minimum length called block length. The block length is the length of the contact spring 31 at total blocking. The block length is the length of the contact spring 31 at maximum compression; thus, each winding is in contact to the adjacent winding. When the contact spring 31 is compressed to its block length, the relative movement of the contact bridge 40 towards the contact bridge carrier 30 stops. The movement of the contact spring 31 can be stopped by the block length of the contact spring 31 or by at least a bumper 75, 76 in the contact bridge carrier 30 (as shown in FIG. 5). The end stop distance F can be measured e.g. by a device for length or distance measurement in case the switching device 10 is not operated and is opened and the contact bridge 40 is moved relative to the contact bridge carrier 30 by an external force. The end stop distance F is the distance between the two end positions of the contact bridge 40 inside the contact bridge carrier 30 (e.g. the end stop distance F is this distance minus the overtravel distance A).

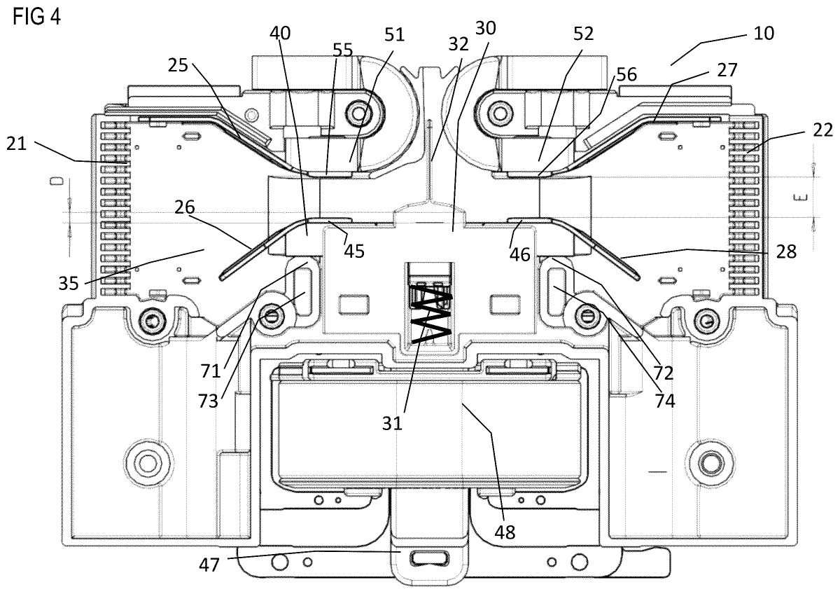

FIG. 4 shows the example of the switching device 10 shown in FIGS. 1 to 3 in case of a short circuit. In FIG. 4, a second phase of the short circuit is illustrated. The switching device 10 includes at least one stopper, realized e.g. as a first and a second stopper 71, 72. The first and the second stopper 71, 72 are connected to the housing 35. In the event of a short circuit, a current sensor detects that the load current is above a predetermined limit and provides a signal to a control circuit that triggers a movement of the armature 47 towards the position of the armature 47 in the switched-off state of the switching device 10. Thus, the contact bridge carrier 30 is moved.

The first and the second stopper 71, 72 limit a movement of the contact bridge 40 in relation to the housing 35 in the second phase of a short circuit. A maximum clearing distance E is a maximum distance of a movement of the contact bridge 40 from an on-position of the contact bridge 40 in a switched-on state of the switching device 10 to the at least one stopper 71, 72 in case of a short circuit. The maximum clearing distance E is e.g. a distance of the first fixed contact 55 to the first stopper 71 (the distance parallel to the direction of the movement of the contact bridge 40) minus a thickness of the contact bridge 40. This distance and the thickness of the contact bridge 40 can be measured by a device for length or distance measurement at an opened and powerless switching device 10. The maximum clearing distance E is larger than the end stop distance F. A difference distance D can be calculated:

$$D = E - B$$

FIG. 5A shows a detail of an example of a contact area of a switching device 10 which is a further development of the example shown in FIGS. 1 to 4. In FIG. 5, the first phase of a short circuit is illustrated similar to FIG. 3. The movement of the contact bridge 40 is stopped by a mechanical part of the switching device 10 that is arranged between the contact bridge 40 and the contact bridge carrier 30. The mechanical part is e.g. a first bumper 75 that is connected to the contact bridge carrier 30. The first bumper 75 stops the movement of the contact bridge 40. The contact bridge carrier 30 may include the first bumper 75. The contact bridge carrier 30 and the first bumper 75 are made e.g. from the same material. The first bumper 75 is formed e.g. as a pin, cylinder or bar. As shown in FIG. 5, the switching device 10 includes a second bumper 76. The second bumper has the same function and structure as the first bumper 75. The two bumpers 75, 76 and a part of the contact bridge 40 are indicated by dashed lines, because they are “behind” a front plate of the contact bridge carrier 30.

In an alternative, not shown embodiment, the first bumper 75 is realized by a transverse rib in the contact bridge carrier 30. The transverse rib is e.g. a part of the plastic of the contact bridge carrier 30. Advantageously, no additional part is necessary. The switching device 10 is free of a second bumper 76.

FIG. 5B shows further details of an example of a switching device 10 which is a further development of the examples shown above. In FIG. 5B, two cross section are shown which are in different planes. The cross section on the left side of the dotted line is a cross section through the contact bridge 40, whereas the cross section on the right side of the dotted line is a cross section through a plane behind the contact bridge 40. As shown on the right side of the dotted line, the switching device 10 includes a return spring 77. One side of the return spring 77 is in contact with the housing 35. The other side of the return spring 77 is coupled to the contact bridge carrier 30. A metal bridge 78 of the switching device 10 couples the other side 78 of the return spring 77 to the contact bridge carrier 30. In the switched-on state of the switching device 10 (as shown in FIG. 5B), a coil current flows through the coil 48, thus the armature 47 is pulled towards the magnetic core 50. More precisely, when the switching device 10 is switched from the switched-off state to the switched-on state, the coil current has a first value in a first duration and then a second value. The second value is lower than the first value. The second value is e.g. lower than 20% or 10% or 5% of the first value. Advantageously, in the first duration a high force is achieved by the high value of the coil current to quickly move the armature 47. The lower value of the coil current is appropriate to hold the armature 47 in the switched-on position.

FIG. 5C shows further details of an example of a switching device 10 which is a further development of the examples shown above. In FIG. 5C, the same cross sections are shown as in FIG. 5B. In the switched-off state of the switching device 10 (as shown in FIG. 5C), no coil current flows through the coil 48; thus an air gap 49 is between the armature 47 and the magnetic core 50.

The contact bridge carrier 30 comprises a limiter 82. The contact bridge carrier 30 and the limiter 80 are made from the same material. The limiter 82 is configured to limit a movement of the contact bridge 40 inside the contact bridge carrier 30 towards the first and the second fixed contact 55, 56. Thus, the contact bridge 40 is able to move inside the contact bridge carrier 30 between the limiter 82 and the first bumper 75.

The return spring 77 holds the contact bridge carrier 30 and thus the contact bridge 40 in a distance to the first and the second terminal contact 51, 52 in the switched-off state of the switching device 10. The return spring 77 provides a force to the contact bridge carrier 30 in a direction away from the first and the second fixed contact 55, 56.

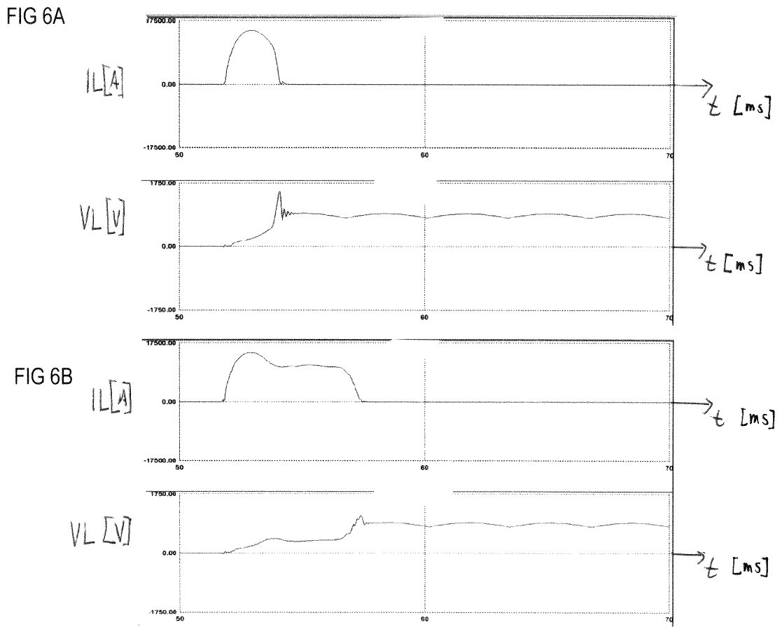

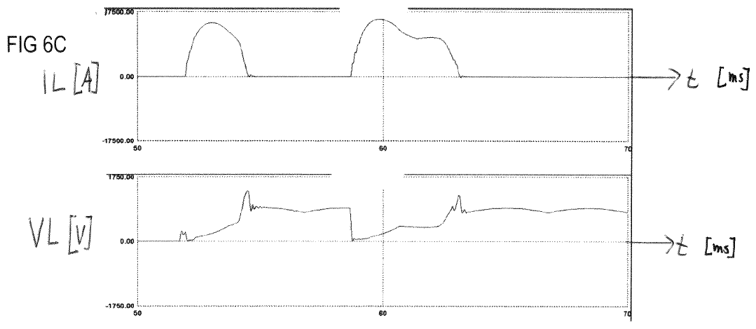

FIG. 6A to 6C show characteristics of different examples of a switching device 10 which are realized e.g. as the examples shown above. In FIGS. 6A to 6C, the short-circuit current IL and a voltage VL are shown as a function of a time t. The short-circuit current IL flows from the first terminal contact 51 to the second terminal contact 52 via the contact bridge 40 and without or with arcs. The voltage VL is tapped between the first terminal contact 51 and the second terminal contact 52. A shunt resistor is inserted in the circuit e.g. between the second terminal contact 52 and a reference potential. The shunt resistor has a value of e.g. 60μΩ. A voltage across the shunt resistor has a value of 150 mV at a load current IL of 2500 A. In FIGS. 6A to 6C, results of measurements are shown. Each Figure shows a short-circuit.

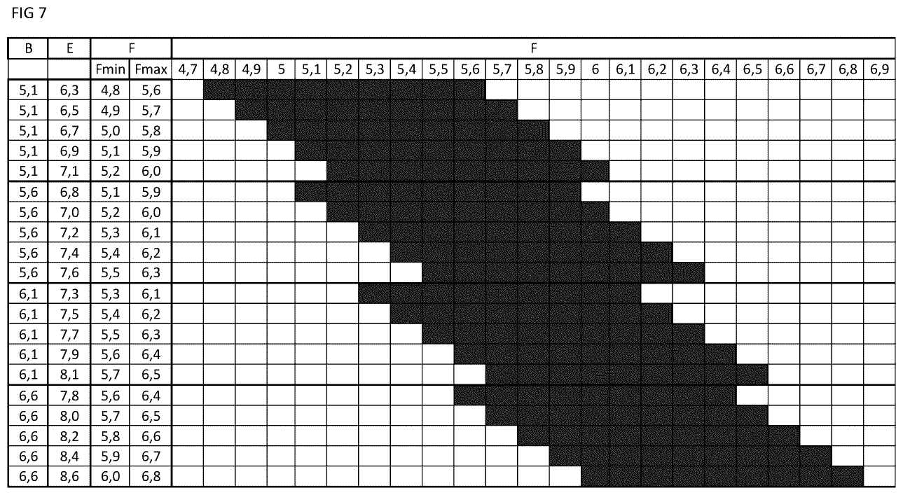

In FIG. 6A, the short-circuit current IL rises due to the short circuit resulting in a movement of the contact bridge 40 described above. Thus, arcs are generated between the movable contacts 45, 46 and the fixed contacts 55, 56. The arcs are quickly extinguished. In an example, without operation of the witching device 10, the short-circuit current IL reaches the value of 20 kA. The operation of the switching device 10 is so fast that the short-circuit current IL reaches e.g. 17500 A and thus remains under the nominal value of 20 kA for the short circuit current. The voltage VL rises after the start of the movement of the contact bridge and remains at about 800 V. FIG. 6A shows an example of the switching device 10 with optimized parameter values, as described below in FIG. 7A.

In FIG. 6B, the switching device 10 shows a longer extinguishing time in comparison to the switching device 10 of FIG. 6A. The maximum clearing distance E has a too small value. The long extinguishing time increases the risk that the arcs result in large amount of material of the movable and fixed contacts 45, 46, 55, 56 which is melted. The melted material may inhibit the movement of the arcs into the arcing chambers 21, 22. As shown in FIG. 6B, the arcs are finally extinguished and the voltage VL of about 800 V drops between the first terminal contact 51 and the second terminal contact 52.

In FIG. 6C, the switching device 10 shows a short extinguishing time, similar to the situation shown in FIG. 6A. However, the contact bridge 40 moves back to the first and the second fixed contact 55, 56 and the short-circuit current IL rises again. After a long extinguishing time the short-circuit current IL drops again and the voltage VL obtains the value of 800 V. In FIG. 6C, the maximum clearing distance E has a too high value (e.g. E=9 mm).

FIG. 7A shows an example of values of parameters of a switching device 10 which is a further development of the examples shown above. Values of the end stop distance F are shown as a function of values of the maximum clearing distance E. The values of the end stop distance F, the clearing distance B and the maximum clearing distance E are given in mm (5.1 mm means 5100 μm). FIG. 7A shows results of a one-dimensional multiphysics simulation. Areas of the end stop distance F which are marked black result in an operating switching device 10.

The switching device 10 operates correctly for a value F of the end stop distance with

Fmin≤F≤Fmax

at a given value E for the maximum clearing distance. Fmin and Fmax are a minimum and a maximum value of the end stop distance and can be calculated according to the equations:

$$Fmin = 4.8 mm + \frac{E - 6.3 mm}{2} ;$$

$$Fmax = 5.6 mm + \frac{E - 6.3 mm}{2}$$

Thus, the end stop distance has a value F according to the equation:

$$4.8 mm + \frac{E - 6.3 mm}{2} \leq F \leq 5.6 mm + \frac{E - 6.3 mm}{2} ,$$

wherein E is a value of the maximum clearing distance.

These values of the maximum clearing distance E and of the end stop distance F result in a correctly operating switching device 10 also in case of a short circuit. For example, at a value E=7.2 mm for the maximum clearing distance, the value F of the end stop distance is Fmin=5.3 mm≤F≤6.1 mm=Fmax. In this example, the clearing distance obtains e.g. a value B=5.6 mm. The value of the maximum clearing distance E depends on the value of the clearing distance B. The values of the end stop distance F have also a small dependency on the value of the clearing distance B. The clearing distance B obtains values in a range between 5.1 mm and 6.6 mm. One can also say: The value of the clearing distance B depends on the value of the maximum clearing distance E. The value of the maximum clearing distance E depends on the value of the end stop distance F.

The maximum clearing distance E obtains values in a range between 6.3 mm and 8.6 mm. Thus, the maximum clearing distance E and the end stop distance F are the most important parameters for a correctly operating switching device 10 also in case of a short circuit. In an example, the values resulting from the equations shall be rounded.

In an example, the end stop distance F, the maximum clearing distance E and the other distances are measured using a device appropriate to measure the dimensions of an object; the distances are measured e.g. by a device for length or distance measurement, e.g. by a laser or a caliper. The caliper allows reading out a measurement result on a ruled scale, a dial or a digital display.

Areas of the end stop distance E which are marked white result in a not correctly operating switching device 10. For example, the parameter values in areas on the left bottom side of the table result in a reconnecting in case of a short circuit with a short-circuit current of 20 kA; the arcs do not move into the arcing chambers 21, 22. The parameter values in areas on the right top side of the table result in difficulties in case of small short circuit currents; a reconnecting may also occur with these parameter values.

The value of the overtravel distance A is e.g. independent from the end stop distance F and the maximum clearing distance E. The travel distance C can be calculated e.g. using C=B+A. The values for the clearing distance B, the travel distance C and the difference distance D result e.g. from the selection of the values for the end stop distance F and the maximum clearing distance E.

The embodiments shown in FIGS. 1 to 7 as stated represent examples of the improved switching device 10 and method; therefore, they do not constitute a complete list of all embodiments according to the improved switching device and method. Actual switching device and methods may vary from the embodiments shown in terms of parts, structures and shape, for example.

### REFERENCE NUMERALS

10 switching device
21, 22 arcing chamber
25 to 28 arc runner
30 contact bridge carrier
31 contact spring
35 housing
40 contact bridge
45, 46 movable contact
47 armature
48 electric coil
49 airgap
50 magnetic core
51 first terminal contact
52 second terminal contact
55, 56 fixed contact
71 first stopper
72 second stopper
73, 74 opening
75, 76 bumper
77 return spring
78 metal bridge
79, 80, 81 armature connection
82 limiter
A overtravel distance
B clearing distance
C travel distance
D difference distance
E maximum clearing distance
F end stop distance
IL short-circuit current
VL voltage

1. A switching device, comprising
a first and a second fixed contact,
a contact bridge,
a first and a second movable contact arranged at the contact bridge,
a contact spring,
a contact bridge carrier which is movable and is coupled to the contact bridge via the contact spring,
a magnetic drive assembly with an electric coil, a magnetic core and an armature, wherein the armature is movable and is connected to the contact bridge carrier,
a housing; and
at least one stopper connected to the housing and configured to limit a movement of the contact bridge in case of a short circuit.

2. The switching device according to claim 1, wherein the switching device is configured that a current flowing in case of a short circuit through the first fixed contact, the first movable contact, the contact bridge, the second movable contact and the second fixed contact and a movement of the contact bridge carrier causes a movement of the contact bridge from an on-position of the contact bridge in a switched-on state of the switching device to the at least one stopper.

3. The switching device according to claim 2, wherein a maximum clearing distance is a maximum distance of the movement of the contact bridge from the on-position of the contact bridge in the switched-on state of the switching device to the at least one stopper in case of a short circuit.

4. The switching device according to claim 1,
wherein the at least one stopper and the part of the housing that is connected to the at least one stopper are made of the same material.

5. The switching device according to claim 1,
wherein the contact bridge carrier and the contact bridge are configured such that a relative movement of the contact bridge in relation to the contact bridge carrier from an on-position of the contact bridge in a switched-on state of the switching device is limited to an end stop distance in case of a short circuit.

6. The switching device according to claim 5,
wherein the relative movement of the contact bridge in relation to the contact bridge carrier from the on-position of the contact bridge in the switched-on state of the switching device is limited by
at least one bumper connected to the contact bridge carrier and/or
a block length of the contact spring.

7. The switching device according to claim 5, wherein the end stop distance depends on a maximum clearing distance.

8. The switching device according to claim 7, wherein the end stop distance has a value F according to the equation:
$$Fmin = 4.8 mm + \frac{E - 6.3 mm}{2} \leq F \leq 5.6 mm + \frac{E - 6.3 mm}{2} = Fmax$$
wherein Fmin and Fmax are a minimum and a maximum value of the end stop distance and E is a value of the maximum clearing distance.

9. The switching device according to claim 1,
wherein a clearing distance is the distance of a movement of the contact bridge from an on-position of the contact bridge in a switched-on state of the switching device to an off-position of the contact bridge in a switched-off state of the switching device in the absence of a short circuit.

10. The switching device according to claim 9, wherein a maximum clearing distance is larger than the clearing distance.

11. The switching device according to claim 9, wherein the maximum clearing distance has a value E according to the equation:
$$B + 1.2 mm \leq E \leq B + 2. mm ,$$
wherein B is a value of the clearing distance.

12. The switching device according to claim 1,
wherein the contact bridge carrier comprises a limiter, and
wherein the limiter is configured to limit a movement of the contact bridge inside the contact bridge carrier towards the first and the second fixed contact.

13. The switching device according to claim 1,
wherein the switching device includes a return spring,
wherein one side of the return spring is in contact with the housing and the other side of the return spring is coupled to the contact bridge carrier, and
wherein the return spring is configured to provide a force to the contact bridge carrier in a direction away from the first and the second fixed contact.

14. (canceled)

15. The switching device according to claim 1, wherein the housing is configured to limit a movement of the armature in case of a short circuit.

16. A method for operating a switching device,
wherein the switching device comprises a first and a second fixed contact, a contact bridge, a first and a second movable contact arranged at the contact bridge, a contact spring, a contact bridge carrier which is movable and is coupled to the contact bridge via the contact spring, a housing, at least one stopper connected to the housing and a magnetic drive assembly with an electric coil, a magnetic core and an armature, wherein the armature is movable and is connected to the contact bridge carrier, and
wherein the method comprises:
limiting a movement of the contact bridge by the at least one stopper in case of a short circuit.
